(19) United States
(12) Patent Application Publication
(10) Pub. No.: US 2009/0013130 A1
(43) Pub. Date: Jan. 8, 2009

(54) MULTIPROCESSOR SYSTEM AND OPERATING METHOD OF MULTIPROCESSOR SYSTEM

(75) Inventor: Shinichiro TAGO, Kawsaki (JP)

Correspondence Address: ARENT FOX LLP, 1050 CONNECTICUT AVENUE, N.W., SUITE 400, WASHINGTON, DC, 20036, US

(73) Assignee: FUJITSU LIMITED, Kawasaki (JP)

(21) Appl. No.: 12/211,602

(22) Filed: Sep. 16, 2008

Related U.S. Application Data
(63) Continuation of application No. PCT/JP2006/305950, filed on Mar. 24, 2006.

(51) Int. Cl. G06F 12/08

(52) U.S. Cl. 711/119; 711/E12.017

(57) ABSTRACT

According to one aspect of embodiments, a multiprocessor system includes a plurality of processors, cache memories corresponding respectively to the processors, and a cache access controller. The cache access controller accesses at least one of the cache memories except one of the cache memories corresponding to one of the processors that issued the indirect access instruction in response to an indirect access instruction from each of the processors. Accordingly, even when one processor accesses data stored in a cache memory of another processor, data transfer between the cache memories is not required. Therefore, latency of an access to the data shared by the plurality of processors can be reduced. Moreover, since the communication between the cache memories is performed only at the time of executing the indirect access instructions, the bus traffic between the cache memories can be reduced.

### CROSS-REFERENCE TO RELATED APPLICATION

This application is a Continuation Application of International Application No. PCT/JP2006/305950, filed Mar. 24, 2006, designating the U.S., the entire contents of which are incorporated herein by reference.

### BACKGROUND

1. Field

The present embodiments relate to a multiprocessor system and an operating method of the multiprocessor system.

2. Description of the Related Art

Generally, in a processor system, a method is employed, in which a high-speed cache memory is mounted between a processor and a main memory, i.e., a main memory unit. This balances the operating speeds between the processor and the main memory. Moreover, in a system requiring high processing capabilities, a multiprocessor system using a plurality of processors is configured. In a multiprocessor system, in which a plurality of processors accesses the main memory, for example, a cache memory is mounted for each processor and each cache memory mutually monitors whether or not it shares the same data with another cache memory (e.g., Japanese Laid-open Patent Publication No. H04-92937).

In this type of multiprocessor system, each cache memory always monitors, in response to an access request for data from another processor, whether or not it shares the data to be accessed. This increases the communication to monitor and increases the usage (traffic) of a bus between cache memories. Furthermore, as the number of processors increases, the number of cache memories to monitor and the number of cache memories to be monitored will increase, respectively, and therefore the hardware becomes complicated. For this reason, the design to construct the multiprocessor system is difficult. Moreover, when one processor reads data stored in a cache memory of another processor, a cache memory having the data stored therein transfers the data to a cache memory of the processor that reads the data. Subsequently, the processor that requested to read will receive the data from the corresponding cache memory. For this reason, the delay time (latency) after the processor requested for access to a cache memory until it receives the data will increase.

### SUMMARY

According to one aspect of embodiments, a multiprocessor system is provided which includes a plurality of processors, a plurality of cache memories corresponding respectively to the plurality of processors, and a cache access controller which accesses at least one of the cache memories except one of the cache memories corresponding to one of the processors that issued the indirect access instruction in response to an indirect access instruction from each of the processors.

### BRIEF DESCRIPTION OF THE DRAWINGS

FIG. 1 illustrates an embodiment.

FIG. 2 illustrates an example of the operation when data in a multiprocessor system shown in FIG. 1 is stored.

FIG. 3 illustrates an example of the operation when data in the multiprocessor system shown in FIG. 1 is loaded.

FIG. 4 illustrates another embodiment.

FIG. 5 illustrates an example of the setting contents of an access destination setting register shown in FIG. 4.

FIG. 6 illustrates an example of the operation when data in a multiprocessor system shown in FIG. 4 is stored.

FIG. 7 illustrates an example of the operation when data in the multiprocessor system shown in FIG. 4 is loaded.

FIG. 8 illustrates a comparative example of the operation when data is loaded.

FIG. 9 illustrates a variation of the embodiment shown in FIG. 1.

FIG. 10 illustrates another variation of the embodiment shown in FIG. 1.

### DETAILED DESCRIPTION OF THE EMBODIMENTS

Hereinafter, the present embodiments will be described using the accompanying drawings.

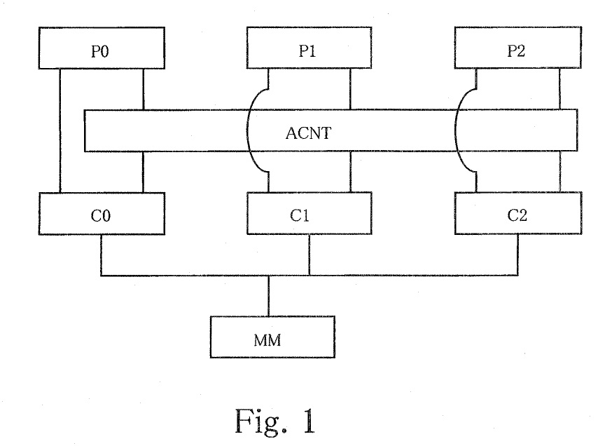

FIG. 1 shows an embodiment. A multiprocessor system comprises processors P0, P1, and P2, cache memories C0, C1, and C2, a cache access controller ACNT, and a main memory MM. The processors P0, P1, and P2 are directly coupled to the cache memories C0, C1, and C2, respectively. The cache access controller ACNT is coupled to the processors P0, P1, and P2 and the cache memories C0, C1, and C2. The main memory MM is coupled to the cache memories C0, C1, and C2.

The cache memories C0, C1, and C2 are directly accessed from the corresponding processor. The cache access controller ACNT receives from the processors P0, P1, and P2 an indirect access instruction, i.e., an instruction to access a cache memory that is not directly coupled to the relevant processor. In response to the received indirect access instruction, the cache access controller ACNT accesses a cache memory corresponding to the indirect access instruction. That is, the cache memories C0, C1, and C2 are also accessed via the cache access controller ACNT from a processor that is not directly coupled thereto. The main memory MM is a main memory unit which the processors P0, P1, and P2 share and use, and is accessed by the cache memories C0, C1, and C2. In this embodiment, the main memory MM is a shared memory having the lowest hierarchical level.

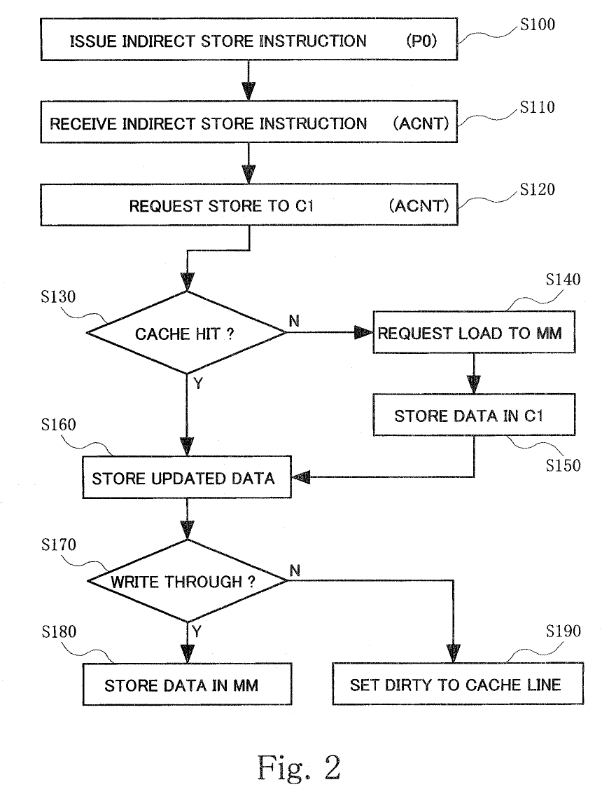

FIG. 2 shows an example of the operation when the data in the multiprocessor system shown in FIG. 1 is stored. In this example, the data of an address X is shared by the processors P0, P1, and is currently not stored in the cache memory C0. Here, the address X indicates an address in the main memory MM.

First, the processor P0 issues an indirect store instruction, which is an instruction to write data to the address X, to the cache access controller ACNT (Operation S100). Here, the indirect store instruction is an instruction to write data to a cache memory of a processor different from the processor that issued the instruction, and is one of the above-described indirect access instructions. Moreover, the examples of methods of specifying a cache memory that is accessed by the above-described indirect store instruction include a method of specifying this in an instruction field. That is, a processor, which will issue the indirect access instruction, specifies information indicative of a cache memory to be accessed, in the instruction field of the indirect store instruction. In this embodiment, in Operation S100, the processor P0 issues the indirect store instruction, in which the information indicative of the cache memory C1 is included in the instruction field, to the cache access controller ACNT.

The cache access controller ACNT receives the indirect store instruction (Operation S110). The cache access controller ACNT requests the cache memory C1 to store (write) the data to the address X (Operation S120). The cache memory C1 determines whether the address X generates a cache hit or a cache miss (Operation S130).

If a cache hit occurred in Operation S130, the cache memory C1 stores the data, which is received from the processor P0 via the cache access controller ACNT, in a cache line including the address X (Operation S160). By Operation S160, the data of the cache memory C1 is updated. In this way, even when the processor P0 updates the data stored in the cache memory C1 of the processor P1, the data needs not to be transferred from the cache memory C1 to the cache memory C0. Accordingly, the latency when the processor P0 updates the data shared with the processor P1 can be reduced.

If a cache miss occurred in Operation S130, the cache memory C1 requests the main memory MM to load (read) the address X (Operation S140). The cache memory C1 loads the data of a cache line including the address X, from the main memory MM. The cache memory C1 stores the cache line that is loaded from the main memory MM (Operation S150). By Operations S140, S150, the data of the address X of the main memory MM is stored in the cache memory C1. The cache memory C1 stores the data, which is received from the processor P0 via the cache access controller ACNT, in a cache line including the address X (Operation S160). By Operation S160, the latest data of the address X is stored in the cache memory C1. Accordingly, for example, when the processor P1 loads the data of the address X after Operation S160, the data needs not to be transferred from the main memory MM or another cache memory. Accordingly, the latency when the processor P1 accesses the data of the address X can be reduced.

The cache memory C1 determines whether or not the data write condition is “write-through” (Operation S170). Here, the write-through is a method, in which when a processor writes data to a cache memory of a higher hierarchical level, the data is written to the cache memory of the higher hierarchical level and at the same time also written to a memory of a lower hierarchical level. If the data write condition is write-through in Operation S170, the cache memory C1 stores the data, which is stored in Operation S160, also in the address X of the main memory MM (Operation S180). If the data write condition is not write-through in Operation S170, the cache memory C1 sets a cache line, to which the data is stored by Operation S160, to “dirty” (Operation S190). Here, the “dirty” implies a state where only data present in a cache memory of a higher hierarchical level is updated but the data present in a memory of a lower hierarchical level is not yet updated.

Moreover, since the communication between the cache memories is performed only at the time of executing the instructions shown in the above-described Operations S100-S190, the bus traffic between the cache memories can be reduced. In the above-described Operations S100-S190, the data of the address X shared with the processor P0 and the processor P1 is not stored in the cache memory C0, and therefore the control of the consistency of the shared data can be simplified.

Although not illustrated in the above Operation flow, the operation of replacing a cache line is the same as that of the conventional method. For example, if there is a cache line to be replaced when a cache line has been stored in Operation S150, the cache line to be replaced is discarded. However, if the cache line to be replaced is “dirty”, the cache line to be replaced is written back to the main memory MM of a lower hierarchical level.

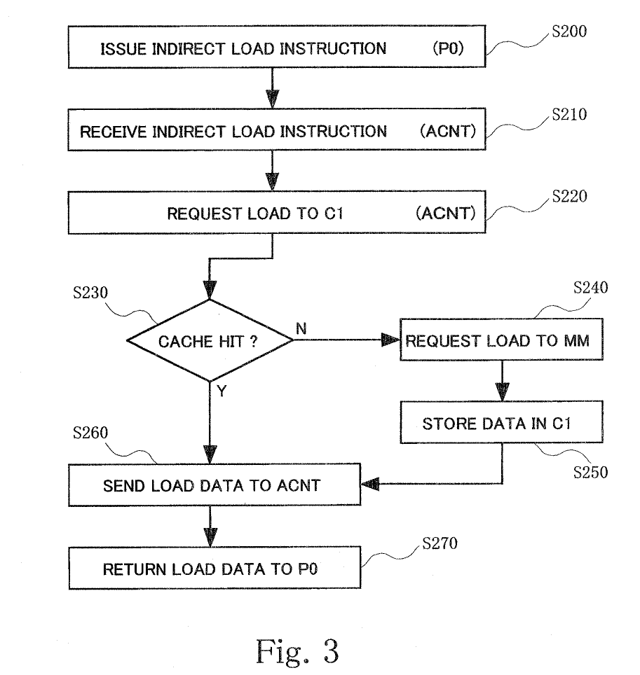

FIG. 3 shows an example of the operation when the data in the multiprocessor system shown in FIG. 1 is loaded. In this example, the data of the address X is shared by the processors P0, P1 and is currently not stored in the cache memory C0.

First, the processor P0 issues an indirect load instruction, which is an instruction to read the data of the address X from the cache memory C1, to the cache access controller ACNT (Operation S200). Here, the indirect load instruction is an instruction to read data from a cache memory of a processor different from the processor that issued the instruction, and is one of the above-described indirect access instructions. That is, the indirect access instruction means an indirect store instruction or an indirect load instruction. Moreover, information indicative of the cache memory C1 to be accessed is specified in the instruction field of the indirect load instruction.

The cache access controller ACNT receives the indirect load instruction (Operation S210). The cache access controller ACNT requests the cache memory C1 to load data of the address X (Operation S220). The cache memory C1 determines whether the address X generates a cache hit or a cache miss (Operation S230).

If a cache hit occurred in Operation S230, the cache memory C1 sends the data of the address X to the cache access controller ACNT (Operation S260). The cache access controller ACNT returns the received data of the address X to the processor P0 (Operation S270). In this way, even when the processor P0 loads the data stored in the cache memory C1 of the processor P1, the data needs not to be transferred from the cache memory C1 to the cache memory C0. Therefore, the latency when the processor P0 loads the data shared with the processor P1 can be reduced.

If a cache miss occurred in Operation S230, the cache memory C1 requests the main memory MM to load the address X (Operation S240). The cache memory C1 loads the data of a cache line including the address X, from the main memory MM. The cache memory C1 stores the cache line loaded from the main memory MM (Operation 5250). Operations S240, S250 are the same processings as those in Operations S140, S150. The cache memory C1 sends the data of the address X to the cache access controller ACNT (Operation S260). The cache access controller ACNT returns the received data of the address X to the processor P0 (Operation S270). By Operation S250, the data of the address X is stored in the cache memory C1. Accordingly, for example, when the processor P1 loads the data of the address X after Operation S250, the data needs not to be transferred from the main memory MM or another cache memory. Therefore, the latency when the processor P1 accesses the data of the address X can be reduced.

Moreover, since the communication between the cache memories is performed only at the time of executing the instructions shown in the above-described Operations S200-S270, the bus traffic between the cache memories can be reduced. In the above-described Operations S200-S270, the data of the address X shared by the processor P0 and the processor P1 is not stored in the cache memory C0, and therefore the control of the consistency of the shared data can be simplified.

Although not illustrated in the above operation flow, the operation of replacing a cache line is the same as that of the conventional method.

As described above, in this embodiment, each of the processors P0, P1, and P2 can access via the cache access controller ACNT the cache memories C0, C1, and C2 that are not directly coupled to each of the processors P0, P1, and P2. Accordingly, for example, even when the processor P0 accesses the data stored in the cache memory C1, the cache memory C1 does not need to transfer the data to the cache memory C0. Accordingly, the latency of an access to the data shared by the processors P0, P1 can be reduced. Moreover, since the communication between the cache memories is performed only at the time of executing the indirect access instructions, the bus traffic between the cache memories can be reduced. As a result, the bus traffic between the cache memories can be reduced, and the latency of an access to the data shared by a plurality of processors can be reduced.

FIG. 4 shows another embodiment. The same element as the element described in FIG. 1 to FIG. 3 is given the same reference symbol, and the detailed description thereof is omitted. A multiprocessor system of this embodiment is configured by adding an access destination setting register AREG to the embodiment described in FIG. 1 to FIG. 3. The access destination setting register AREG is coupled to the processors P0, P1, and P2 and the cache access controller ACNT. The access destination setting register AREG is a rewritable register, in which information indicative of a cache memory to be accessed by an indirect access instruction is set for each of the processors P0, P1, and P2. In this embodiment, the information indicative of an access destination cache memory does not need to be specified in the instruction field of the indirect access instruction.

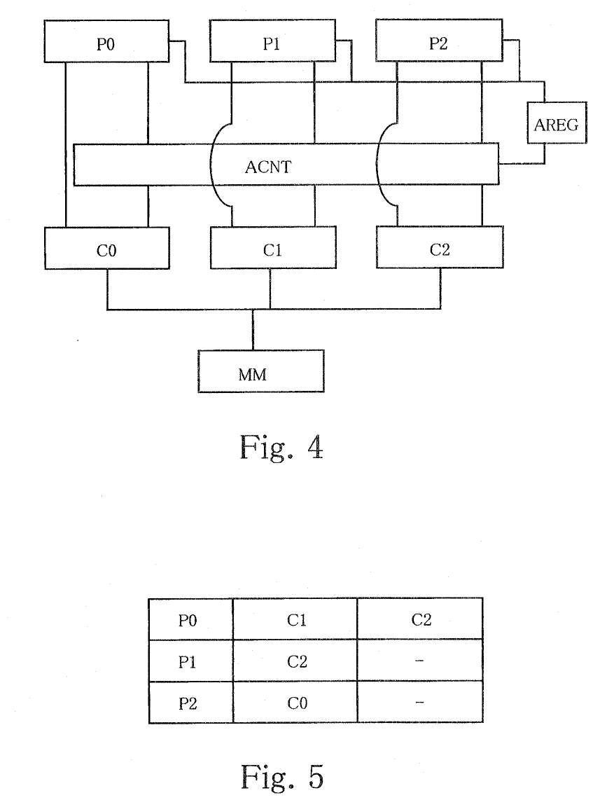

FIG. 5 shows an example of the setting contents of the access destination setting register AREG shown in FIG. 4. The access destination setting register AREG has a field to store information indicative of a cache memory to be accessed by the indirect access instruction from each of the processors P0, P1, and P2. In the setting in the diagram, the processors P0, P1, and P2 access the cache memories C1 and C2, C2, and C0, respectively, via the cache access controller ACNT by using the indirect access instructions.

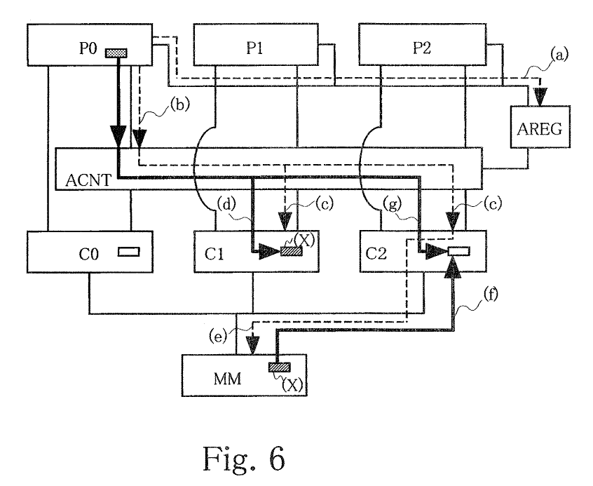

FIG. 6 shows an example of the operation when the data in the multiprocessor system shown in FIG. 4 is stored. (X) in the diagram indicates the data of the address X. The dashed line in the diagram indicates a flow of communication to control data transfer. The solid line indicates a data flow. In this example, the data of the address X is shared by the processors P0, P1, and P2. Moreover, the cache memory C1 currently stores the data of the address X therein, while the cache memories C0, C2 currently do not store the data of the address X therein.

The processor P0 sets information indicative of a cache memory to be accessed by an indirect access instruction to the access destination setting register AREG ((a) in FIG. 6) as shown in FIG. 5. The processor P0 issues the indirect store instruction to store data in the address X, to the cache access controller ACNT ((b) in FIG. 6). The cache access controller ACNT requests the cache memories C1, C2 corresponding to the information set in the access destination setting register AREG to store the data to the address X ((c) in FIG. 6).

Since the cache memory C1 currently stores the data of the address X therein, it generates a cache hit. The cache memory C1 stores the data, which is received from the processor P0 via the cache access controller ACNT, into the cache line that generated a cache hit ((d) in FIG. 6). The cache memory C1 sets the written cache line to “dirty”.

Since the cache memory C2 currently does not store the data of the address X therein, it generates a cache miss. The cache memory C2 requests the main memory MM to load the address X ((e) in FIG. 6). The cache memory C2 loads the data of a cache line including the address X, from the main memory MM. The cache memory C2 stores the cache line that is loaded from the main memory MM ((f) in FIG. 6). The cache memory C2 stores the data, which is received from the processor P0 via the cache access controller ACNT, into the stored cache line ((g) in FIG. 6). The cache memory C2 sets the written cache line to “dirty”.

By the above-described operations (a) to (g), the latest data of the address X is stored in the cache memories C1, C2. Subsequently, when the processors P1, P2 request access to the address X, the data needs not to be transferred from the main memory MM or the cache memory of another processor, and therefore the latency can be reduced.

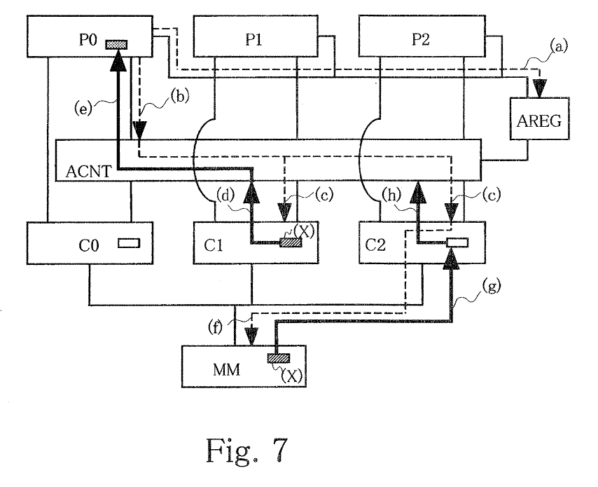

FIG. 7 shows an example of the operation when the data in the multiprocessor system shown in FIG. 4 is loaded. The meaning of the arrow in the diagram is the same as that of FIG. 6. In this example, the data of the address X is shared by the processors P0, P1, and P2. Moreover, the cache memory C1 currently stores the data of the address X therein, while the cache memories C0, C2 currently do not store the data of the address X therein.

The processor P0 sets information indicative of a cache memory to be accessed by the indirect access instruction to the access destination setting register AREG ((a) in FIG. 7) as shown in FIG. 5. The processor P0 issues the indirect load instruction to load the data of the address X, to the cache access controller ACNT ((b) in FIG. 7). The cache access controller ACNT requests the cache memories C1, C2 corresponding to the information set in the access destination setting register AREG to load the data of the address X ((c) in FIG. 7).

Since the cache memory C1 currently stores the data of the address X therein, it generates a cache hit. The cache memory C1 sends the data of the address X to the cache access controller ACNT ((d) in FIG. 7). The cache access controller ACNT returns the received data of the address X to the processor P0 ((e) in FIG. 7).

Since the cache memory C2 currently does not store the data of the address X therein, it generates a cache miss. The cache memory C2 requests the main memory MM to load the address X ((f) in FIG. 7). The cache memory C2 loads the data of a cache line including the address X, from the main memory MM. The cache memory C2 stores the cache line that is loaded from the main memory MM ((g) in FIG. 7). The cache memory C2 sends the data of the address X to the cache access controller ACNT ((h) in FIG. 7). Since the cache access controller ACNT has already received the data of the address X by the operation (d) in the diagram, the data received from the cache memory C2 is discarded.

As in the operation (c) in the diagram, when the cache access controller ACNT requests a plurality of cache memories to load data, the data to be returned to the processor P0 is selected based on a certain criterion. In this embodiment, for the data to be returned to the processor P0, the data which the cache access controller ACNT received first is selected.

As shown in the above-described operations (a) to (h), the processor P0 can request other cache memories C1, C2 to load the data of the address X even when the data of the address X is currently not stored in the cache memory C0. Accordingly, the processor P0 can receive the data of the address X without waiting for the data to be transferred from the main memory MM if the data of the address X is currently stored in either of the cache memories C1, C2. Accordingly, the latency when the processor P0 requests to load the data of the address X can be reduced.

As described above, also in this embodiment, the same effects as those of the embodiment described in FIG. 1 to FIG. 3 can be obtained. In this embodiment, the information indicative of an access destination cache memory needs not be specified in the instruction field of the indirect access instruction. Accordingly, the instruction field of the indirect access instruction can be used as is with the same configuration as that of the instruction field of the conventional store instruction and load instruction that are used for a cache memory corresponding to a processor.

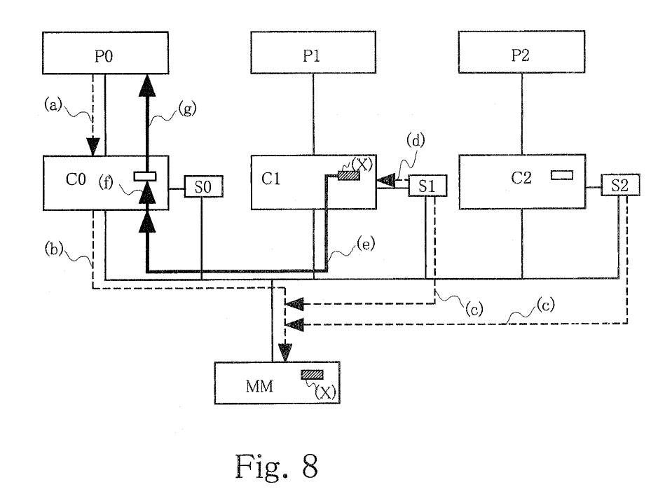

FIG. 8 shows a comparative example with respect to the above-described embodiments. The cache memories C0, C1, and C2 of a multiprocessor system of the comparative example have external access monitoring units S0, S1, and S2, respectively, which monitor an access between the cache memories. The external access monitoring units S0, S1, and S2 are coupled to the cache memories C0, C1, and C2 and the main memory MM. The meaning of the arrow in the diagram is the same as that of FIG. 6. In this example, the cache memory C1 currently stores the data of the address X therein, while the cache memories C0, C2 currently do not store the data of the address X therein. FIG. 8 illustrates a case where under this condition the processor P0 requests to load the address X. This is the same as the conditions for the operations of Operations S200, S210, S220, S230, S260, and S270 of FIG. 3 and the initial state of FIG. 7.

The processor P0 requests to load the address X ((a) in FIG. 8). Since the cache memory C0 currently does not store the data of the address X therein, it generates a cache miss. The cache memory C0 requests the main memory MM to load the address X ((b) in FIG. 8). The external access monitoring units S1, S2 detect this load request for the address X to the main memory MM ((c) in FIG. 8). Since the cache memory C1 currently stores the data of the address X therein, the external access monitoring unit S1 disables the load request of the address X from the cache memory C0 to the main memory MM. Since the load request for the address X to the main memory MM has been disabled, the external access monitoring unit S1 issues an instruction to transfer a cache line including the address X to the cache memory C0, to the cache memory C1 ((d) in FIG. 8). The cache memory C1 transfers the cache line including the address X to the cache memory C0 ((e) in FIG. 8). The cache memory C0 stores the received cache line ((f) in FIG. 8). After this, the cache memory C0 returns the data of the address X to the processor P0 ((g) in FIG. 8).

In this way, after transferring the data of the address X to the cache memory C0 from the cache memory C1, the data of the address X is returned to the processor P. Accordingly, the latency when the processor P0 requests to load the address X will increase. Moreover, since the external access monitoring units S1, S2 always monitor an access to the main memory MM, the bus traffic will increase as compared with the above-described embodiments.

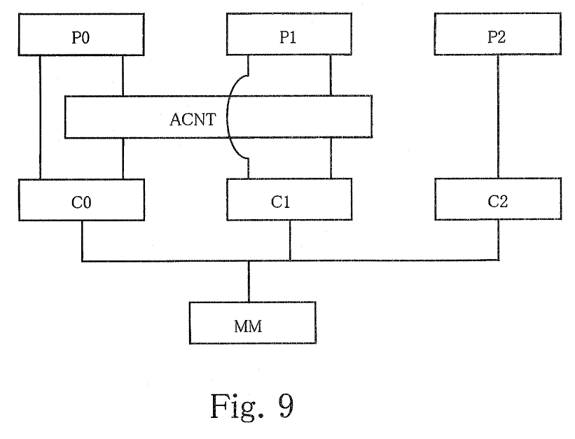

Note that, in the embodiment described in FIG. 1 to FIG. 3, an example has been described, in which the information indicative of a cache memory to be accessed by the indirect access instruction is specified in the instruction field of the indirect access instruction. However, for example, instead of specifying this information in the instruction field, the cache access controller ACNT may always access each of the cache memories C1, C2 and C0 respectively in response to the indirect access instruction from the processors P0, P1, and P2. Alternatively, if a configuration as shown in FIG. 9 is used, the cache memory accessed by the indirect access instruction is uniquely determined as the cache memory C1 for the processor P0 and the cache memory C0 for the processor P1. In the above example, the instruction field of the indirect access instruction can be used as is with the same configuration as that of the instruction field of the conventional store instruction and load instruction that are used for a cache memory corresponding to the relevant processor.

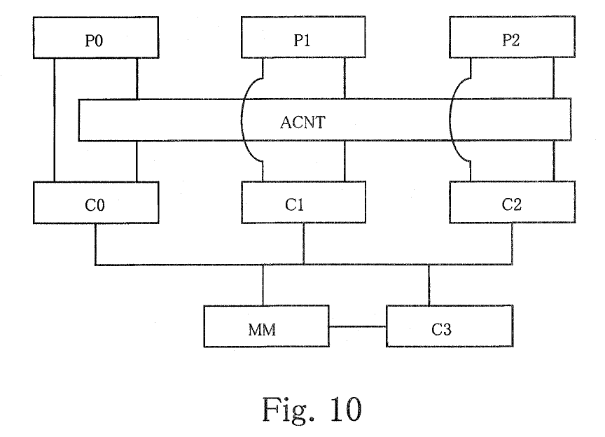

In the embodiment described in FIG. 1 to FIG. 3, an example of requesting the main memory MM to load the address X in Operation S140 of FIG. 2 and Operation S240 of FIG. 3 has been described. However, for example, as shown in FIG. 10, a cache memory C3 shared by each of the processors P0, P1, and P2 may be provided as a memory of a lower hierarchical level. In this case, the cache memory C1 first requests the cache memory C3 having a higher hierarchical level than the main memory MM to load the address X. Accordingly, a higher speed operation is possible in the case where the data of the address X is stored in the cache memory C3, than when accessing the main memory MM. Also in this case, the data of the address X is stored in the cache memory C1. Accordingly, the same effects as those of the embodiment described in FIG. 1 to FIG. 3 can be obtained.

In the embodiment described in FIG. 4 to FIG. 7, an example has been described, in which the processor P0 sets the information shown in FIG. 5 to the access destination setting register AREG. However, for example, other processors P1, P2 may set the information shown in FIG. 5 to the access destination setting register AREG. Moreover, the setting to the access destination setting register AREG may be completed before the processor P0 issues an instruction to the cache access controller ACNT. Also in this case, the same effects as those of the embodiment described in FIG. 4 to FIG. 7 can be obtained.

In the embodiment described in FIG. 4 to FIG. 7, an example has been described, in which when the cache memory C1 generated a cache hit and the cache memory C2 generated a cache miss in the operations (c) to (g) of FIG. 7, the cache memory C2 stores the cache line. However, for example, the cache access controller ACNT may, in response to the data being received from the cache memory C1 by the operation (d) of FIG. 7, issue an instruction to cancel the data load request to the cache memory C2. Alternatively, each of the cache memories C0-C2 sends a notification of whether each generated a cache hit or a cache miss, to the cache access controller ACNT. Then, in response to having received the notification of a cache hit from the cache memory C1, the cache access controller ACNT may issue an instruction to cancel the data load request to the cache memory C2. Thereby, the cache memory C2 stops loading the data of the address X from the main memory MM. This can reduce the bus traffic between the cache memory and the main memory MM. Also in this case, the same effects as those of the embodiment described in FIG. 4 to FIG. 7 can be obtained.

A proposition of the embodiments is to reduce the bus traffic between the cache memories and to reduce the latency of an access to the data shared by a plurality of processors.

In the embodiments described above, a multiprocessor system includes a plurality of processors, cache memories corresponding to the respective processors, and a cache access controller. The cache access controller, in response to an indirect access instruction from each of the processors, accesses a cache memory except a cache memory corresponding to the processor that issued the indirect access instruction. Accordingly, even when one processor accesses data stored in a cache memory of another processor, the data transfer between the cache memories is not required. Therefore, the latency of an access to the data shared by a plurality of processors can be reduced. Moreover, since the communication between the cache memories is performed only at the time of executing the indirect access instructions, the bus traffic between the cache memories can be reduced. The bus traffic between the cache memories can be reduced, and the latency of an access to the data shared by a plurality of processors can be reduced.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

What is claimed is:

1. A multiprocessor system, comprising:
a plurality of processors;
a plurality of cache memories corresponding respectively to the plurality of processors; and
a cache access controller which accesses at least one of the cache memories except one of the cache memories corresponding to one of the processors that issued the indirect access instruction in response to an indirect access instruction from each of the processors.

2. The multiprocessor system according to claim 1, further comprising
a rewritable access destination setting register, in which information indicative of at least one of the cache memories to be accessed by the indirect access instruction is set for each of the processors, wherein
the cache access controller accesses at least one of the cache memories corresponding to the information set in the access destination setting register in response to the indirect access instruction.

3. The multiprocessor system according to claim 1, wherein
each of the processors specifies information indicative of at least one of the cache memories to be accessed by the indirect access instruction in an instruction field of the indirect access instruction; and
the cache access controller accesses at least one of the cache memories corresponding to the information specified in the instruction field in response to the indirect access instruction.

4. The multiprocessor system according to claim 1, wherein
the cache access controller accesses data of at least one of the cache memories when an address to be accessed generates a cache hit in at least one of the cache memories accessed by the indirect access instruction.

5. The multiprocessor system according to claim 1, further comprising a shared memory that is shared by the processors and has a lower hierarchical level than that of the cache memories, wherein
at least one of the cache memories accessed by the indirect access instruction reads from the shared memory data of a cache line including the address to be accessed when the address to be accessed generates a cache miss, and stores the read data therein; and
the cache access controller accesses data stored in at least one of the cache memories corresponding to the indirect access instruction.

6. A method of operating a multiprocessor system comprising a plurality of processors and a plurality of cache memories corresponding respectively to the plurality of processors, the method comprising accessing at least one of the cache memories except one of the cache memories corresponding to one of the processors that issued the indirect access instruction in response to an indirect access instruction from each of the processors.

7. The method of operating a multiprocessor system according to claim 6, further comprising:
rewritably setting access destination information indicative of at least one of the cache memories accessed by the indirect access instruction, for each of the processors; and
accessing at least one of the cache memories corresponding to the access destination information in response to the indirect access instruction.

8. The method of operating a multiprocessor system according to claim 6, further comprising:
specifying information indicative of at least one of the cache memories accessed by the indirect access instruction in an instruction field of the indirect access instruction; and
accessing at least one of the cache memories corresponding to the information specified in the instruction field in response to the indirect access instruction.

9. The method of operating a multiprocessor system according to claim 6, further comprising accessing data of at least one of the cache memories when an address to be accessed generates a cache hit in at least one of the cache memories accessed by the indirect access instruction.

10. The method of operating a multiprocessor system according to claim 6, wherein
the processors sharing a shared memory having a lower hierarchical level than that of the cache memories, and the method further comprising:
reading from the shared memory data of a cache line including the address to be accessed when an address to be accessed generates a cache miss in at least one of the cache memories accessed by the indirect access instruction;
storing the read data in at least one of the cache memories corresponding to the indirect access instruction; and
accessing the data stored in at least one of the cache memories corresponding to the indirect access instruction.
